(19) United States
(12) Patent Application Publication
(10) Pub. No.: US 2003/0084622 A1
(43) Pub. Date: May 8, 2003

(54) Components for multipane window unit sash assemblies

(75) Inventors: Robert E. Hornung, Southport, CT (US); John S. France, Cuyahoga Falls, OH (US)

Correspondence Address: LAW OFFICE OF BARRY R LIPSITZ, 755 MAIN STREET, MONROE, CT, 06468, US

(73) Assignee: Sashlite, LLC, Westport, CT (US)

(21) Appl. No.: 10/285,343

(22) Filed: Oct. 30, 2002

Related U.S. Application Data
(60) Provisional application No. 60/338,920, filed on Nov. 5, 2001.

(51) Int. Cl. E06B 7/12; E04C 2/54

(52) U.S. Cl. 52/172; 52/786.13

(57) ABSTRACT

Various desiccant, vapor barrier and/or sealant components are provided for a multipane window unit sash assembly having an integral glazing pane mounting structure. The components have varying shapes and features, which may include glazing pane mounting surfaces, spacer functions, dual seal capabilities and muntin bar retaining functions. Various materials can be used to fabricate the components, including adhesive, sealant, sealant strip, tape, foam, resin, metallic or plastic materials, or combinations of such materials. The components may be preformed, extruded onto the sash, or otherwise applied. Automated assembly of the components to the sash is also disclosed.

This application claims the benefit of U.S. provisional application No. 60/338,920, filed Nov. 5, 2001, the entire contents of which is hereby incorporated by reference.

### BACKGROUND OF THE INVENTION

The present invention relates generally to commercial, residential and architectural windows and doors and, more particularly, to vapor barriers, desiccants, spacer structures and simulated muntin bar structures for multipane window units and sash assemblies.

### DESCRIPTION OF THE RELATED ART

As is currently well known in the art, insulating glass units, or IG units, are widely used as elements of windows, skylights, doors and related products, including vehicles. Such units are used to reduce heat loss from building interiors in winter, and reduce heat gain into air-conditioned buildings in summer. The insulating glass units are typically formed separately from the sash, and then in a separate step the insulating glass unit is installed in a sash.

Alternative methods for manufacturing insulating glass structures, where the IG unit is formed integrally with the sash itself, are disclosed in J. France U.S. patent application Ser. No. 09/307,825 ('825) filed on May 7, 1999, entitled “Integrated Multipane Window Unit and Sash Assembly and Method for Manufacturing the Same”, now U.S. Pat. No. 6,286,288, corresponding to PCT published application WO 00/68539 dated Nov. 16, 2000; J. France U.S. patent application Ser. No. 09/907,528 filed on Jul. 17, 2001, entitled “Integrated Multipane Window Unit and Sash Assembly and Method for Manufacturing the Same”; R. Hornung et al. U.S. patent application Ser. No. 09/882,295 ('295) filed on Jun. 15, 2001, entitled “Insulating Glass Sash Assemblies with Adhesive Mounting and Spacing Structures”; R. Hornung et al. U.S. patent application Ser. No. 09/925,293 ('293) filed on Aug. 9, 2001, entitled “Method for Fabricating an Integrated Multipane Window Sash”; and R. Hornung U.S. patent application Ser. No. 10/004,112 ('112) filed on Nov. 15, 2001, entitled “Window Sash Assembly with Hinged Glazing Components”, all incorporated herein by reference. In addition to providing a comprehensive explanation of the prior art, the aforementioned '288 patent discloses an improved but less complex insulating glass structure that is integrated with the window sash.

More particularly, the aforementioned '288 patent discloses a multipane window unit in which a sash frame is formed having an integral spacing structure upon which glazing panes are directly affixed. The integral spacing structure provides vertical glazing surfaces extending from the sash. Adhesive can be affixed to the vertical glazing surfaces to attach the glazing panes. In this manner, a rigid, structural sash frame is formed prior to attachment of the glazing panes, thereby eliminating the need for using separately manufactured insulating glass units, while obtaining similar and improved thermal benefits.

Further improvements to insulating glass structures for use in windows, doors and the like, while incorporating the basic concept of the aforementioned '288 patent, i.e., the provision of a sash and IG unit in an integrated structure, can be found in the aforementioned '295, '293 and '112 patent applications. In addition to providing a comprehensive explanation of the prior art, these patent applications disclose improved but less complex insulating glass structures that are integrated with the window sash. In particular, the '295 application discloses, inter alia, an integrated insulating glass and sash structure where parallel glass panes are directly mounted to and supported on the sash by an adhesive mounting or an adhesive mounting and spacing structure.

Advantageously, such an adhesive can be applied to the sash directly in the form of a bead, such as a bead of sealant (or a combination of sealants or sealant and tape, sealant and foam, etc.) which can also function as the spacer element between the glass panes. Alternatively, the adhesive can be co-extruded (or post-extruded) with the sash profile. Still further, the adhesive can comprise an integrated, single component desiccated sealant-adhesive glazing material. In a particularly advantageous embodiment, this material can be pre-formed into a variety of shapes and sizes, thereby providing, when adhered to the sash profile, an integrated sash/glazing assembly. Methods for assembling multipane window units using the disclosed adhesive spacing and mounting structure are also disclosed.

The '293 application discloses, inter alia, methods for manufacturing integrated multipane window sashes. The '112 application discloses, inter alia, a window sash structure with hinged glazing components, such as hinged glazing beads.

It would be advantageous to further improve structures such as those described above by providing desiccant and vapor barrier components that are economical to fabricate and easy to install. It would be further advantageous to provide such components that facilitate the assembly of muntin bar structures between the panes of a multipane window or door. It would be still further advantageous to provide such components that are manufactured of adhesive, sealant, sealant strip, tape, extrusion with tape, foam, resin, metallic or plastic materials, or combinations of such materials (hereinafter referred to as “Component Materials”). Also advantageous would be the provision of such components that are pre-molded or molded in place, are robotically applied, applied via a snap, wedge or compression fit, are manually applied, comprise extrusions, or comprise any other suitable structure that may serve as a desiccant and/or vapor barrier.

The present invention provides the above and further advantages.

### SUMMARY OF THE INVENTION

According to the invention, various components are provided for a multipane window unit sash assembly having an integral glazing pane mounting structure. In one embodiment, the mounting structure comprises an interior channel having two interior side walls and an interior bottom wall. The inventive component comprises at least one of a desiccant, vapor barrier or sealant material applied to the two interior side walls and bottom wall.

The component material can, for example, be extruded onto the side and bottom walls of the channel. The side walls terminate at top edges extending from the channel, and the component material can also be applied to the top edges, e.g., to complete a vapor barrier. The material can have both desiccating and vapor barrier properties and can comprise, for example, any of the previously mentioned Component Materials. Moreover, the material can extend from a top edge of a first one of the interior side walls to the bottom wall, across said bottom wall, and continue to a top edge of the second one of the interior side walls. The material can also continue past the top edges onto exterior surfaces of the mounting structure. Further, the component material can be preformed to fit into the interior channel.

The mounting structure can be designed to receive at least one glazing pane. The component can include a projection or “fin” extending therefrom for receiving at least one additional glazing pane. In an illustrated embodiment, the mounting structure is adapted to receive two glazing panes, and the projection is adapted to receive at least a third glazing pane.

In another embodiment of the invention, a glazing pane mount is provided for a multipane window unit sash assembly. The mount comprises a spacer for attachment (e.g., by adhesive or mechanical means) to the sash. The spacer has mounting surfaces for at least two glazing panes. The spacer also includes at least one muntin bar retainer between the mounting surfaces.

The muntin bar retainer can comprise at least one groove in the spacer. The groove can be adapted to accommodate a retaining element for a muntin bar. Alternatively, the groove can be adapted to directly receive an end of the muntin bar or to receive an additional glazing pane.

In an illustrated embodiment, two substantially parallel grooves are provided in the spacer to accommodate a muntin bar retaining element. The retaining element can comprise a clip adapted to snap into the at least one groove. The spacer can comprise, for example, any of the previously mentioned Component Materials, which can be adhesively mounted to the sash.

The mounting surfaces of the spacer can be provided on flanges extending from the spacer. In such an embodiment, each flange in combination with the sash defines a respective channel therebetween for accommodating at least one sealant. The sealant is adapted to adhesively mount the glazing panes in position with respect to the spacer. The sealant can either partially or substantially fill the channel.

A glazing pane mount for a multipane window unit sash assembly is disclosed which comprises a spacer for attachment to the sash. The spacer has mounting surfaces for at least two glazing panes. The mounting surfaces are provided on flanges extending from the spacer and the flanges in combination with the sash define a channel therebetween for accommodating at least one sealant. At least one sealant is adapted to adhesively mount the glazing panes in position with respect to the spacer. Edges of the flanges provide a first seal to the glazing pane, and the sealant provides a second seal to the glazing pane. The spacer can comprise, for example, any of the previously mentioned Component Materials. The spacer can be preformed and can be adapted, e.g., for mechanical attachment (e.g., friction or snap fit) or adhesive attachment to the sash.

Components are also disclosed for a multipane window unit sash assembly having an integral glazing pane mounting structure, wherein the mounting structure comprises at least two upright walls, each connected to a respective transverse top wall portion. The component comprises at least one of a desiccant, vapor barrier or sealant material applied to the two upright walls and top wall portions. The respective transverse top wall portions can be unconnected to each other. Alternatively, the respective transverse top wall portions can be connected together. The material can be extruded onto the upright and top wall portions, and can cover any part of or substantially all exterior surfaces of the upright and top wall portions. In an embodiment where the respective transverse top wall portions are connected to each other, the material may extend all of the way thereacross.

Sealant can be applied to an exterior surface of the component material on each of the upright walls, for use in mounting respective glazing panes to the upright walls via the material. The material can, for example, comprise any of the previously mentioned Component Materials, and can be preformed to fit over the mounting structure.

The mounting structure can be adapted to receive at least one glazing pane via the material adjacent at least one of the upright walls. In addition, the material can have a projection or “fin” extending therefrom for receiving at least one additional glazing pane. In an illustrated embodiment, the mounting structure is adapted to receive two glazing panes, and the projection is adapted to receive at least a third glazing pane.

In an embodiment where the respective transverse top wall portions of the mounting structure are unconnected to each other with a space therebetween, a portion of the component is advantageously adapted to fit into the space. In an illustrated embodiment, a portion of the component is adapted to snap or be pressure fit into the space provided by the unconnected transverse top wall portions of the mounting structure. Also illustrated are embodiments where the inventive components are provided in roll form for application to the mounting structure.

In another illustrated embodiment, components are provided for a multipane window unit sash assembly having an integral glazing pane mounting structure that comprises an upright wall extending from a base portion of the sash assembly. The upright wall has first and second opposed surfaces. The component comprises at least one of a desiccant, vapor barrier or sealant material applied to the base portion adjacent to the first surface of the upright wall. The second surface of the upright wall provides a mounting surface for a first glazing pane. The component provides a mounting surface for a second glazing pane. The material of the component can comprise, e.g., any of the previously mentioned Component Materials. Moreover, the material can be extruded onto the base portion. The component can serve as a spacer to maintain a fixed space between said first and second glazing panes.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a is an exploded cross-sectional view of a component in accordance with the invention that is adapted to fit over a window sash profile;

FIG. 2 is a schematic illustration showing the assembly of a component onto a sash profile from a spool of components;

FIGS. 3A-3C illustrate the application of a component to the interior of a sash profile channel via a nozzle, as well as the assembly of glazing panes to the sash profile;

FIG. 4 illustrates a component in accordance with the invention that includes an arrangement for securing muntin bars between adjacent glazing panes;

FIG. 5 illustrates various dual seal component configurations in accordance with the invention that can be applied to a sash profile, as well as the assembly of glazing panes to the sash profile;

FIG. 6 illustrates a component configuration in accordance with the invention that forms an effective vapor barrier by covering all surfaces of the sash profile that reside between adjacent glazing panes;

FIGS. 7A-7C illustrate the assembly of a component such as that shown in FIG. 4 to a sash profile with means for mounting muntin bars between adjacent glazing panes;

FIGS. 8A-8C illustrate component configurations in accordance with the invention which provide a channel for sealant when the component is mounted or adhered to a sash profile, with the capability of providing a dual seal structure;

FIGS. 9A-9C illustrate a further component configuration in accordance with the invention, wherein glazing panes are mounted to the component via sealant or other adhesive;

FIGS. 10A-10C illustrate various single seal component configurations in accordance with the invention that can be applied to a sash profile, which configurations differ from those of FIGS. 5A-5C in that they are mounted directly to the sash profile without an intervening second seal;

FIGS. 11A-11C illustrate various additional single seal component configurations in accordance with the invention, as well as the assembly of glazing panes to the sash profile;

FIGS. 12A-12C illustrate additional dual seal component configurations in accordance with the invention, as well as the assembly of glazing panes to the sash profile;

FIGS. 13A and 13B illustrate an embodiment where the component has a fin for mounting a glazing pane, and is particularly useful for a triple pane construction;

FIG. 14 shows an embodiment where a first glazing pane is mounted to an upright leg, with a second glazing pane being mounted to a component that is adjacent to the leg;

FIGS. 15A-15C illustrate a component in the form of a block that snaps into a glazing pane mounting and spacing structure; and

FIGS. 16A-16C illustrate a component that is mounted to the sash profile by a press-fit or snapping arrangement.

### DESCRIPTION OF THE PREFERRED EMBODIMENTS

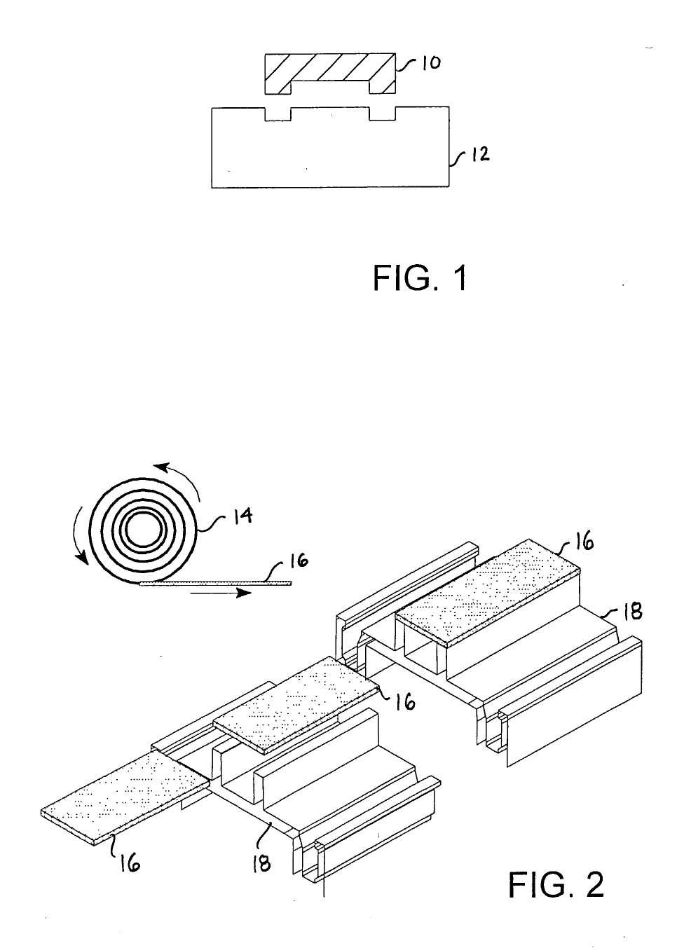

Referring now to FIG. 1, a component 10 is provided that is adapted to mate with a sash profile 12. The sash profile may be fabricated from vinyl, e.g., polyvinyl chloride (PVC) or any other material used for window or sash frames, such as aluminum, wood, other plastics and the like. Although not required, it would be advantageous for the color of component 10 to match the color of sash profile 12 for aesthetic reasons. The sash profile is provided for use in manufacturing an insulating glass window. The sash profile 10 can be fabricated in any known manner, for example, by extrusion. Although only a cross-section of the profile 10 is illustrated, it should be appreciated that the profile material will be provided in various lengths necessary to assemble a complete sash frame, which may be square, rectangular, oval, circular, or any other custom window shape as well known in the art.

The component 10 can comprise, for example, a desiccant, a vapor barrier, a sealant, or a combination of these materials. For example, desiccated sealants are known in the art, and can be used in accordance with the present invention to both secure glazing panes (mounted on either side of the component 10) to the sash profile 12 and to absorb moisture in the space between the glazing panes. Such a desiccated sealant may also have vapor barrier properties, so that volatiles and/or other vapors that may be emitted by the sash profile material are prevented from being introduced into the space between the glazing panes, thereby preventing fogging of the interior surfaces of the panes. The glazing panes are typically glass panes, although panes of other materials can be substituted. Such panes can comprise, for example, clear or frosted plastic, such as Plexiglas, tempered glass, safety glass, security glass, privacy glass, or any other known glazing material.

The component 10, which may be of any suitable shape, can be fabricated from, e.g., any of the previously mentioned Component Materials with tape on exterior surfaces thereof to provide adhesive mounting surfaces to mount the component to the sash profile and/or to mount glazing panes to the component. A separate sealant material can be provided instead of or in addition to a tape for adhesively mounting the component to the sash profile and/or to mount glazing panes to the component. Sealant and/or tape can also be provided between the component and the glazing panes in order to implement a dual seal embodiment. Such embodiments are discussed in greater detail below.

The inventive structure is intended to provide, inter alia, a desiccating structure that will adsorb and/or absorb vapor, gases, moisture, chemical volatiles or any other contaminates that may reside, appear, or form within the air space of a multipane window unit and sash assembly, such as, for example, window units and sash assemblies of the type disclosed in the aforementioned '288 patent. The term “window unit” as used herein is not meant to be limited to windows, but is to be interpreted as broadly as possible to include all window type structures such as, e.g., glass doors, skylights, refrigeration units with transparent doors and/or cases, vehicle windows, and the like.

The invention can also provide a barrier or lining that will prohibit vapor, gases, moisture, chemical volatiles or any other contaminates from passing from the structure and/or surface of a multipane window unit and sash assembly into the air space between adjacent glazing panes. The barrier/desiccant/spacer component of the present invention may have numerous shapes as depicted in the Figures and described in greater detail below. The dimensions of thickness, width, and height may also vary as related to the total assembly or its various parts. The barrier/desiccant/spacer component may be manufactured and fabricated (e.g., sized) as a separate member and applied to the sash assembly.

The barrier/desiccant/spacer component may be co-manufactured or processed such as by co-extrusion, co-application, or co-joining as the multipane window unit and sash assembly extrusion/profile/shape is formed, and prior to the assembly, joining, or molding of the sash corner. Moreover, the barrier/desiccant/spacer component may comprise any of the previously mentioned Component Materials. It can be fabricated from pliable or rigid material, or any single, dual, or multiple version thereof in any combination or layering of tape, adhesive, metal, extrusion, spray or other coating or combination required to meet industry test standards. The component of the present invention can comprise any material that effectively prohibits the passage of vapor, gases, moisture, chemical volatiles or any other contaminates that must be isolated from the internal air space between adjacent glazing panes.

The inventive barrier/desiccant/spacer component may be attached to the multipane window unit and sash assembly by adhesive, tape, spray coating, liquid application, co-extrusion, or by mechanical means such as a snap fit, wedge fit, or any other suitable type of joinery that precludes or utilizes chemical bonding, such as with glue. Any of the above application methods may be manual or automated. Additionally, the inventive component may provide one or more mounting surfaces for attaching glazing panes in any one or more of “single seal”, “dual seal” or “tape seal” configurations via, e.g., sealants and/or adhesives used to fasten the glazing panels to the mounting surfaces.

In one embodiment, as illustrated in FIG. 2, the component is applied in an automated process from a roll 14 of components 16. The components 16 can comprise a desiccant, vapor barrier, spacer, or any combination thereof. As each component is unwound from roll 14, it is mounted (e.g., adhesively) on the sash profile 18. For example, the component may be fabricated from any of the previously mentioned Component Materials. Alternatively, an adhesive tape, foam, sealant or chemical compound can be applied to one or both of the sash profile 18 or component 16 in order to allow the component to be affixed to the sash profile. Other application techniques will be apparent to those skilled in the art based upon an understanding of the present disclosure.

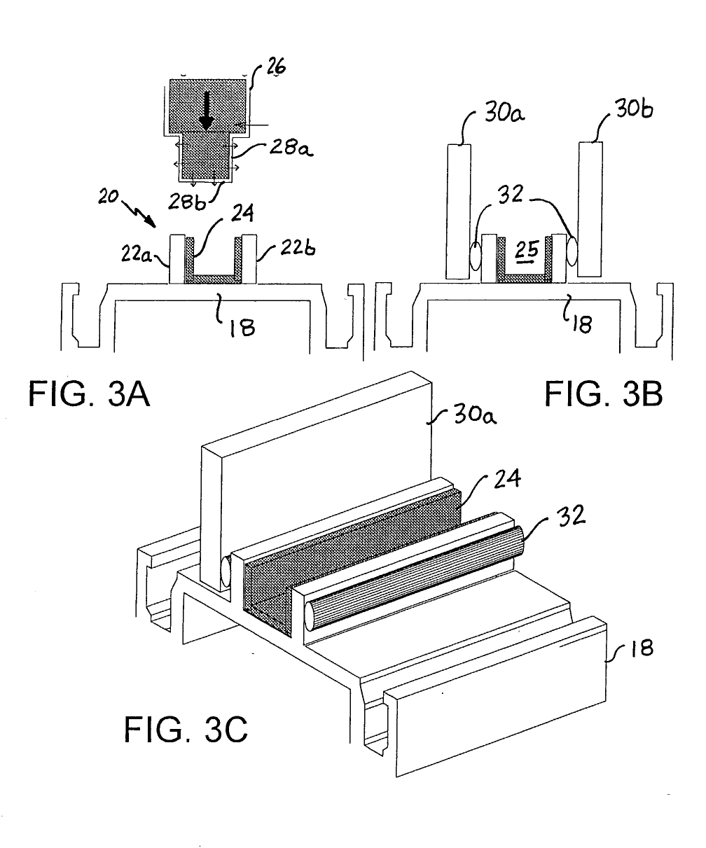

FIGS. 3A-3C illustrate an embodiment of a sash profile wherein a spacer structure generally designated 20 includes legs 22a, 22b. These legs together with sash profile 18 form a channel 25 into which component 24 (which is in a fluid form, such as a desiccated sealant) is injected. Injector nozzle 26 includes side wall injectors 28a and bottom wall injectors 28b.

The legs 22a and 22b serve as mounting structures for glazing panes 30a, 30b. The glazing panes are mounted to the legs via a sealant or other adhesive 32. Although only one strip of sealant 32 is shown on each leg, it should be appreciated that multiple strips can be provided to provide a dual, triple, or greater seal. The sealant can 32 can be in the form of one or more narrow strips or beads as shown, or can cover the entire external side wall of each leg. The glazing panes can rest on the surface of the sealant, or be partially or substantially fully embedded therein.

In the embodiment of FIGS. 3A-3C (as well as in other embodiments disclosed herein) there is no need to cover all of the sash profile material that is exposed to the space between the glazing panes if a vapor barrier function is not desired. If the component is only to serve as a desiccant, it can be provided in a continuous or discontinuous form between the glazing panes. Thus, in FIGS. 3A-3C, the desiccant can be placed within the channel 25 without the continuous coverage shown. Such a desiccant could be in the form of a rope, foam, or blocks placed into channel 25. The particular desiccant structure chosen will depend on the degree of desiccating properties required for the particular application.

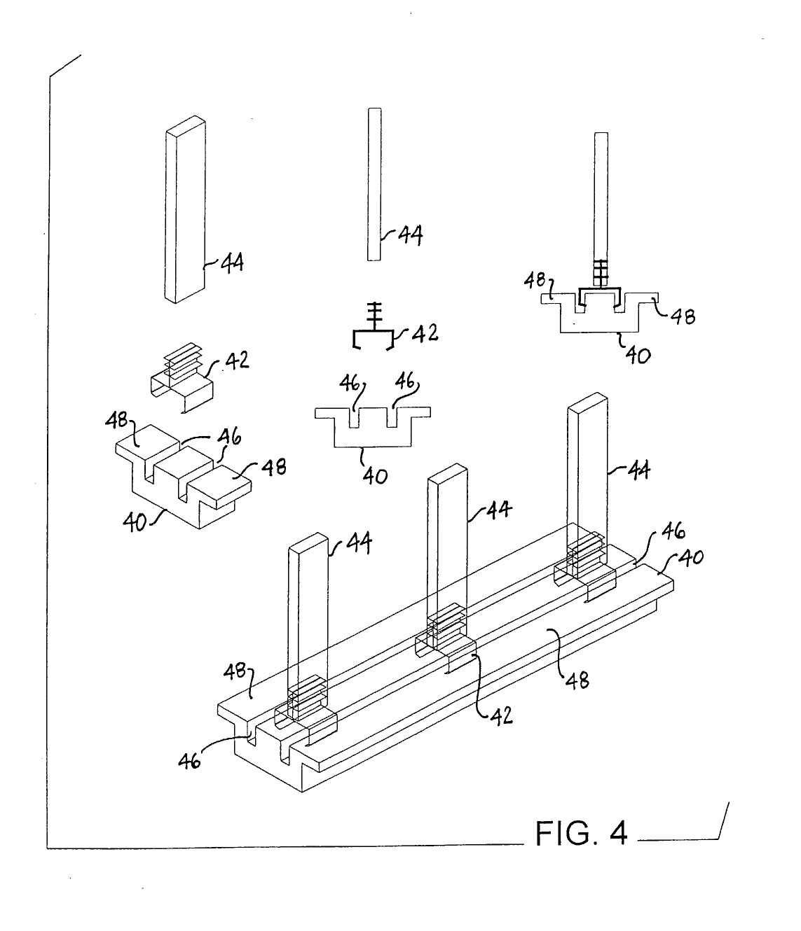

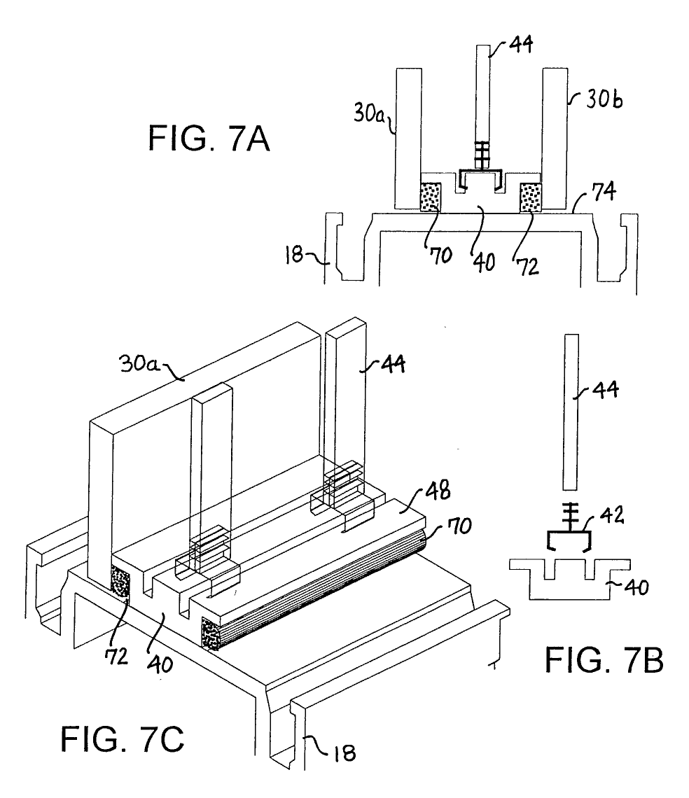

FIG. 4 illustrates a component 40 that serves as a spacer for glazing panes. The spacer component 40 can be mounted (e.g., adhesively) onto a sash profile 18 as shown in FIGS. 7B, 7C. Component 40 can be fabricated, for example, from a desiccated foam material, or any other appropriate material that has the necessary structural integrity for mounting glazing panes to the sash assembly in spaced relation. Such materials may include any of the previously mentioned Component Materials.

Flanges 48 on the component 40 define the top of a channel 72 (see FIG. 7B), the bottom of the channel being defined by the surface 74 of the sash profile 18. The channel is partially or completely filled with a sealant 70 that is used to adhere the glass panes to the component 40 and/or to the surface of the sash profile 18. As with the other embodiments, the sealant 70 can comprise one sealant or a plurality of different sealants, and can be desiccated and/or formulated to serve as a vapor barrier. Moreover, a plurality of separate sealant beads can be provided within the channel 72, to provide a dual or triple (or greater) seal.

The component 40 further includes parallel channels 46 which are designed to accept a muntin bar retaining clip 42. In this manner, muntin bars 44 can be attached, via clips 42, to the spacer and retained by the spacer in the space between adjacent glazing panes. Although a specific embodiment for the muntin bar retaining clips and corresponding channels in the spacer component 40 are illustrated, it should be appreciated that many other implementations can be substituted without departing from the intended scope of the invention. For example, the muntin bars may be directly wedged, press fit, snapped or adhesively mounted to the spacer component 40 with or without a retaining clip. The spacer component 40 would, of course, be provided with a corresponding receptacle and/or projection to accommodate such a wedge, press or snap fit. Other muntin bar arrangements are also contemplated through the use of a suitably designed spacer component and corresponding muntin bar structure.

It is noted that a similar channel, like channels 46, could instead be provided to hold a third glazing pane therein. Components are also envisioned where such channels are provided for all of the glazing panes, or at least some of the panes.

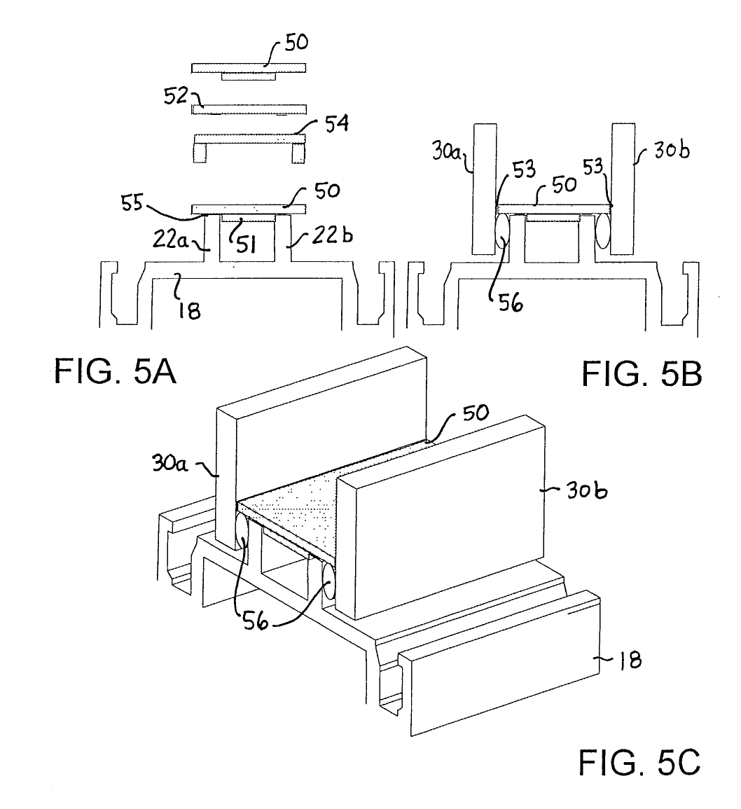

FIG. 5A shows different component embodiments, namely, components 50, 52 and 54 which are adapted to fit into, on and/or over the legs 22a, 22b of the sash profile 18. Although component 50 is shown assembled onto the profile in FIGS. 5A-5C, it should be appreciated that component 52 or 54 can be substituted therefor. Moreover, additional components of varying shapes can be provided in accordance with the teachings of the invention. The specific structure of the component is not critical, as long as it is able to function as an effective desiccant, vapor barrier and/or spacer for the ultimate window unit.

The components 50, 52 and 54 illustrated in FIGS. 5A-5C are designed to provide a dual seal in combination with sealant 56. In particular, each of the components includes a seal on at least one surface thereof that contacts glazing pane 30a or 30b. As illustrated in FIG. 5B, component 50 includes adhesive tape, sealant or chemical adhesive 53 that forms a first seal with glazing panes 30a and 30b. A second seal between the glazing panes and the legs 22a and 22b of the sash profile is provided by sealant 56. When component 52 or 54 is substituted for component 50, a similar first seal can be provided by adhesive tape, sealant and/or chemical adhesive on the edges of component 52 or 54. A third seal can also be provided in any of the embodiments shown in FIGS. 5A-5C, by providing an adhesive tape, sealant and/or chemical adhesive 55 between the top edges of the legs 22a, 22b and the bottom surface of the corresponding component 50, 52 or 54.

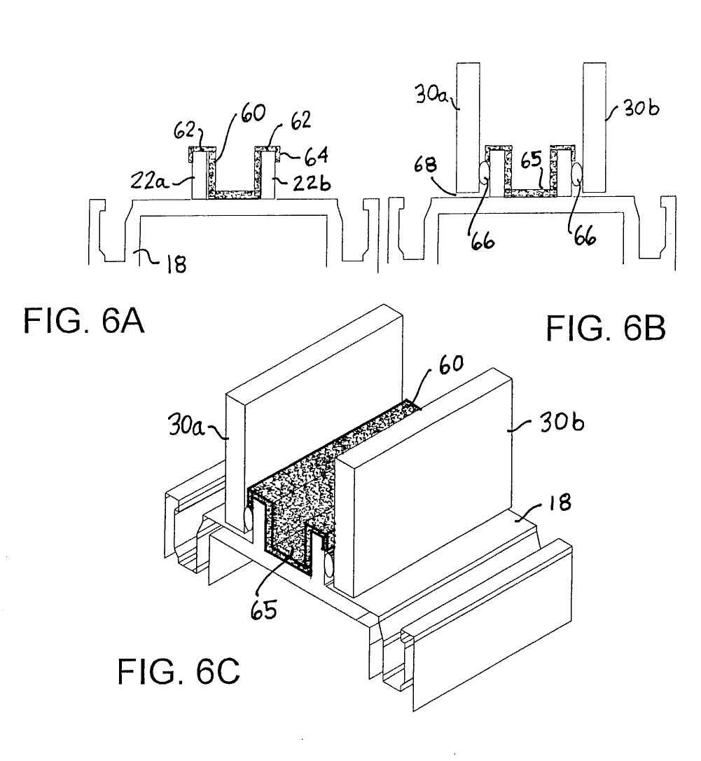

FIGS. 6A-6C illustrate an embodiment where a preformed component 60 is adapted to be inserted into the channel formed between legs 22a and 22b of sash profile 18. The preformed component 60 includes top flanges 62 to cover the top edges of the legs 22a, 22b. Optional returns 64 are also shown which cover a top portion of the exterior mounting surfaces of legs 22a, 22b. As shown in FIGS. 6B, 6C, glazing panes are mounted to the support legs 22a, 22b of the sash profile 18 via sealant or other adhesive 66. Although the sealant is illustrated as being in bead or strip form (beads and strips being considered herein to be equivalent), it can just as easily be applied in any other form, such as a plurality of parallel strips or a wide strip that covers substantially the entirety of the exposed portion of the legs. Additionally, sealant can be applied either to the glazing panes, to the legs, or both and can extend onto the outer surfaces of the component returns 64 either by intentional application thereto or by oozing over when the sealant is sandwiched between the glazing pane and associated support leg. The sealant may also be applied to or ooze onto the edge of the glazing pane, so that it partially or completely fills the gap 68 between the glazing pane edge and the surface of the sash profile.

FIGS. 7A-7C illustrate the assembly of a component 40 to the sash profile, as discussed above in connection with FIG. 4.

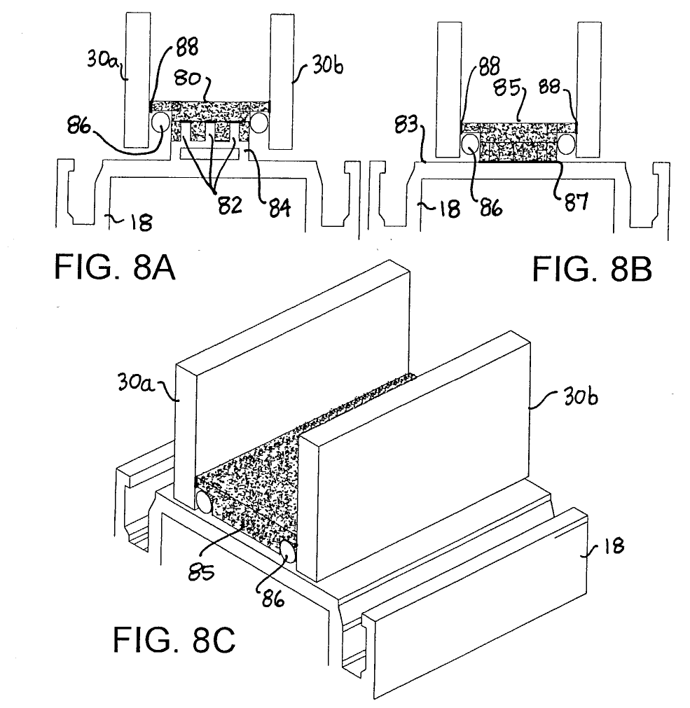

FIGS. 8A-8C depict embodiments where components such as a semi-rigid foam desiccant and/or vapor barrier are provided. In the embodiment of FIG. 8A, a desiccating and/or vapor barrier component 80 is installed over mating ribs 82 of a spacing and mounting structure 84 that is integral with the sash profile 18. The component 80 can comprise any of the previously mentioned Component Materials or any other suitable material or combinations thereof. Sealant 86 is provided to adhere the glazing panes 30a, 30b to the component 80. The sealant 86 can also or alternatively be used to mount the glazing panes to the spacing and mounting structure 84. For example, when the glazing panes are pressed against the sealant, the sealant may deform so that it covers portions of both the component 80 and the structure 84. A wide band of sealant could also be applied to cover side walls of both the component 80 and the spacing and mounting structure 84 prior to the mounting of the glazing panes. Multiple beads of the same or different sealant can also be used. An dual (or higher order) seal can be provided through the use of an optional adhesive or sealant material 88 applied to the edges of the component 80.

FIG. 8B shows an embodiment where a component 85 is attached directly to the surface 83 of the sash profile 18. For example, component 85 can be mounted via an adhesive layer (e.g., sealant or tape) 87. The component 80 can comprise any of the previously mentioned Component Materials or any other suitable material or combinations thereof. The sealant 86 in FIG. 8B can have various properties and structures as discussed above in connection with FIG. 8A. Moreover, an optional dual (or higher order) seal can be provided by adhesive or sealant layers 88 on the edges of component 85. FIG. 8C is a perspective view of the embodiment of FIG. 8B. It is noted that component 85 can be applied before or after the sash profile is assembled into a frame. Potentially, labor savings can be realized and automation facilitated by applying component 85 prior to assembly of the frame.

The component 85 of FIG. 8B (or any of the comparable components disclosed herein) can optionally be provided with a groove, similar to the grooves 46 illustrated in FIG. 4. Where only one such groove is provided, an additional glazing pane can be inserted into this groove, to provide a triple pane embodiment. Additional grooves could be provided for additional glazing panes, thereby allowing four pane (or more) embodiments.

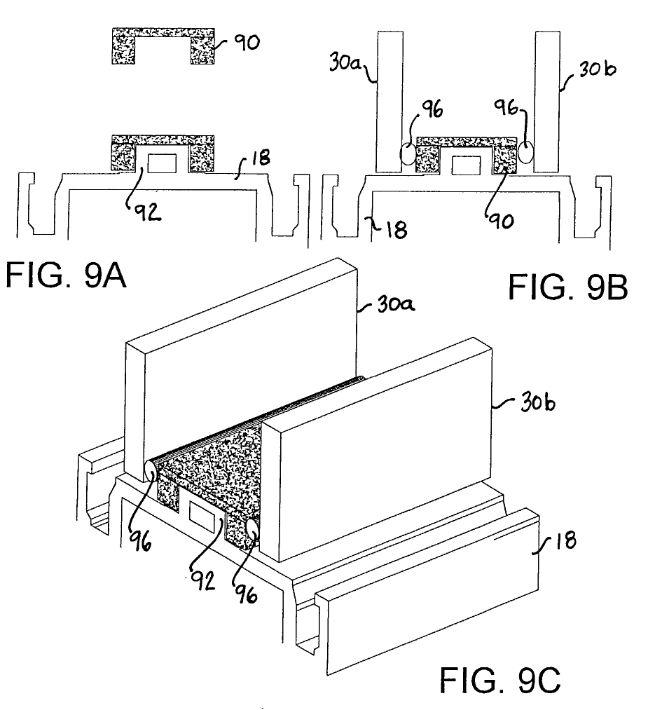

FIGS. 9A-9C illustrate further embodiments in accordance with the present invention. In particular, a desiccating and/or vapor barrier component 90 is provided to fit over a corresponding spacing and mounting structure 92 which is integral with sash profile 18. The spacing and mounting structure 92 can be of any suitable shape and dimension. One or more beads of sealant 96 are provided to affix the glazing panes 30a, 30b to the component 90. Component 90 can be press fit over the spacing and mounting structure 92 and held by friction, or it can be adhesively affixed to the spacing and mounting structure. The component 90 can comprise any of the previously mentioned Component Materials or any other suitable material or combinations thereof.

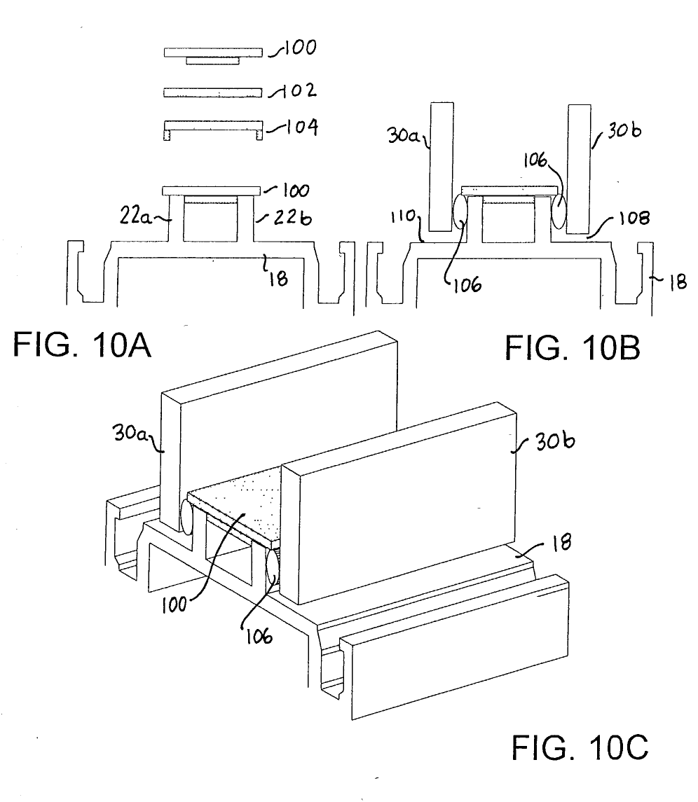

FIGS. 10A-10C illustrate embodiments that are somewhat similar to those of FIGS. 5A-5C, but which do not provide a dual seal between the glazing panes and the desiccant and/or vapor barrier components.

FIG. 10A shows different component embodiments, namely, components 100, 102 and 104 which are adapted to fit into, on and/or over the legs 22a, 22b of the sash profile 18. Although component 100 is shown assembled onto the profile in FIGS. 10A-10C, it should be appreciated that component 102 or 104 can be substituted therefor. Moreover, additional components of varying shapes can be provided in accordance with the teachings of the invention. The specific structure of the component is not critical, as long as it is able to function as an effective desiccant, vapor barrier and/or spacer for the finished window unit.

Sealant 106 can comprise a single bead of sealant as shown, a wide strip of sealant that covers substantially the entire outer surface of the respective leg 22a or 22b, or a plurality of sealant strips (which can each comprise the same or a different sealant). It will be appreciated by those skilled in the art that when the glazing panes are pressed toward the respective mounting surfaces of legs 22a, 22b, the sealant 106 will flatten and spread (e.g., whet out). It is envisioned that the sealant may spread to the point that it fills part or all of the gap 108 between the edge of the glazing pane and the surface 110 of the sash profile 18. In such an instance, the perimeter edge of the glazing pane will be partially or fully embedded in the sealant 106.

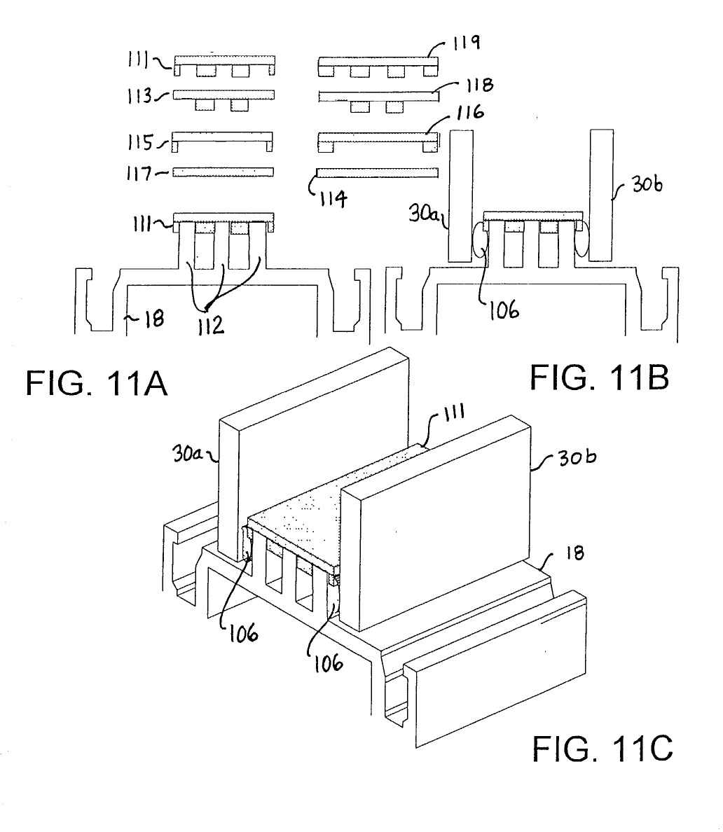

Additional component embodiments 111, 113, 114, 115, 116, 117, 118, 119 are illustrated in FIGS. 11A-11C. These components are adapted to fit on, over or partially within an integral spacing and mounting structure of the sash profile 18. In the embodiment shown in these figures, the integral spacing and mounting structure comprises legs 112. It should be appreciated that the illustrated structure is an example only, and that other spacing and mounting structures can be substituted for the legs 112.

As with the other embodiments disclosed herein, the desiccant and/or vapor barrier components 111, 113, 114, 115, 116, 117, 118, and 119 of FIGS. 11A-11C can comprise any of the previously mentioned Component Materials, or combinations of such materials. Such components can also be pre-molded or molded in place, be robotically applied, or comprise extrusions or any other suitable structure that may serve as a desiccant and/or vapor barrier. The illustrated components may also be configured to provide dual (or higher order) seal structures, e.g., by providing adhesive and/or sealant on the edges thereof that contact the glazing panes. Such adhesive or sealant may also be provided on surfaces of the components that contact portions of the sash profile. The sealant 106 illustrated in FIGS. 11A-11C can be as described above in connection with FIGS. 10A-10C.

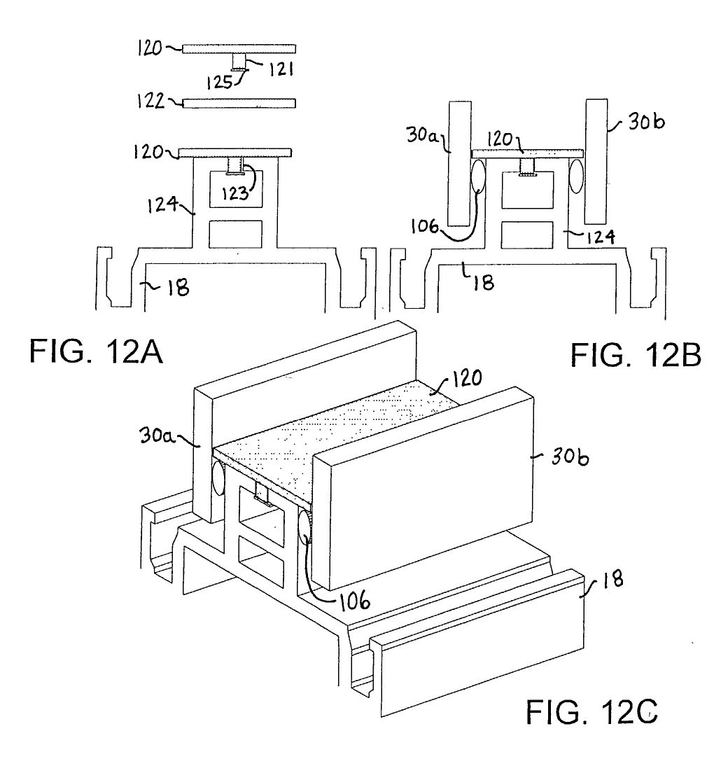

FIGS. 12A-12C show examples of further desiccant and/or vapor barrier components 120 and 122. Component 120 includes a plug 121 with a flexible or pliable retaining portion 125. The plug 121 is adapted to be inserted into a corresponding opening 123 in spacing and mounting structure 124 of sash profile 18. The retaining portion 125 bends to allow insertion of plug 121 into opening 123, and then returns to its original position to lock the component 120 to the spacing and mounting structure 124. Alternatively, the plug 121 can be adhesively or pressure fit into opening 123. Automated equipment is envisioned for assembling the components to the spacing and mounting structure.

Component 122 provides an alternative structure that can be adhesively mounted to spacing and mounting structure 124 by chemical adhesive, tape, sealant, or other suitable adhesive material. The remaining elements illustrated in FIGS. 12A-12C, including sealant 106 and glazing panes 30a, 30b, are equivalent to the same elements discussed above in connection with the other embodiments of the invention. Additional features of the other embodiments, e.g., the provision of a dual or higher order seal, can also be applied to the embodiments of FIGS. 12A-12C.

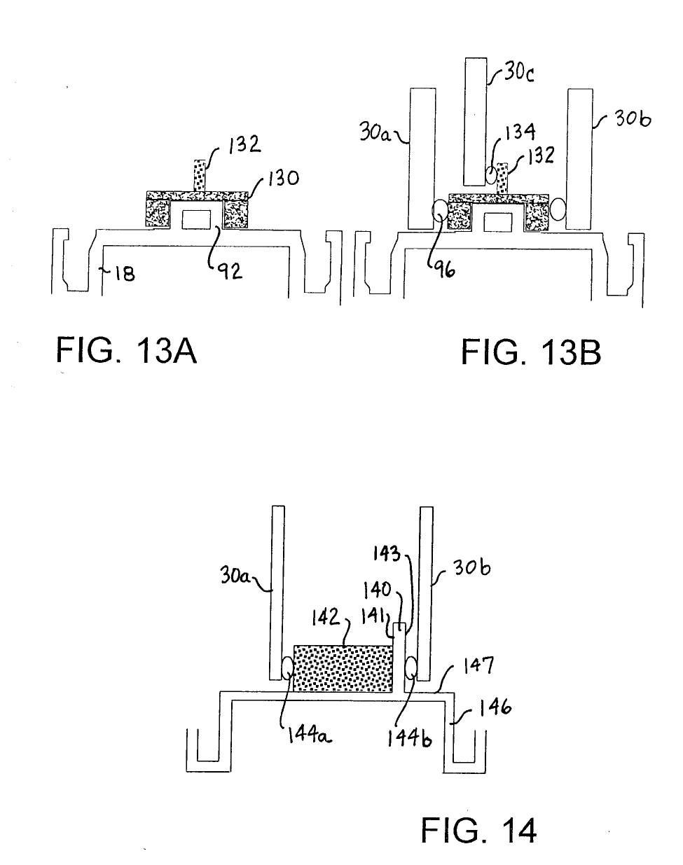

FIGS. 13A and 13B show an embodiment similar to that of FIGS. 9A-9C, with the addition of a projection (“fin”) 132 on the component 130. Fin 132 is used to provide a mounting surface for a third glazing pane 30c. A bead of sealant 134 is provided between the glazing pane 30c and the fin 132 for adhesively mounting the glazing pane to the fin. As with the components described above, component 130 can comprise any material or combination of materials having the desired desiccating and/or vapor barrier properties, including pre-formed foam materials, tape, or any of the previously mentioned Component Materials. Component 132 will also have sufficient stiffness to support the third glazing pane 30c.

FIG. 14 illustrates an embodiment in which the mounting structure comprises an upright wall 140 having a first surface 141 and a second opposed surface 143 extending from a base portion 147 of sash assembly 146. The component 142 comprises at least one of a desiccant, vapor barrier or sealant material applied to the base portion 147 adjacent to the first surface 141 of the upright wall 140. It will be appreciated by those skilled in the art that for the component 142 to serve as an effective vapor barrier, it should cover all portions of upright wall 140 that would be exposed within the airspace between glazing panes 30a and 30b. By covering such portions, any volatiles or other vapors that could be emitted by the upright wall will be blocked by the component.

The second surface 143 of the upright wall 140 provides a mounting surface for a first glazing pane 30b, e.g., via sealant or other adhesive 144b. The component 142 provides a mounting surface for a second glazing pane 30a, e.g., via sealant or other adhesive 144a.

It is noted that sealant or other adhesive 144a is optional in the event that component 142 itself has adhesive properties for use in mounting glazing pane 30a. Moreover, a layer of adhesive may be used to mount component 142 to the sash assembly 146. Such a layer of adhesive could be placed between component 142 and surface 141 of upright wall 140, between component 142 and the base portion 147 of the sash profile, or both.

The embodiment of FIG. 14 is also useful in providing a triple pane structure. For example, a third glazing pane (not shown) could be mounted to the portion of surface 141 that extends above the top of component 142. In such an embodiment, the edge of the third glazing pane can either rest on the component 142, or be spaced above the component 142 to provide a gap. A suitable sealant or adhesive would be used to adhere the third glazing pane to the surface 141 and/or to the top of the component 142.

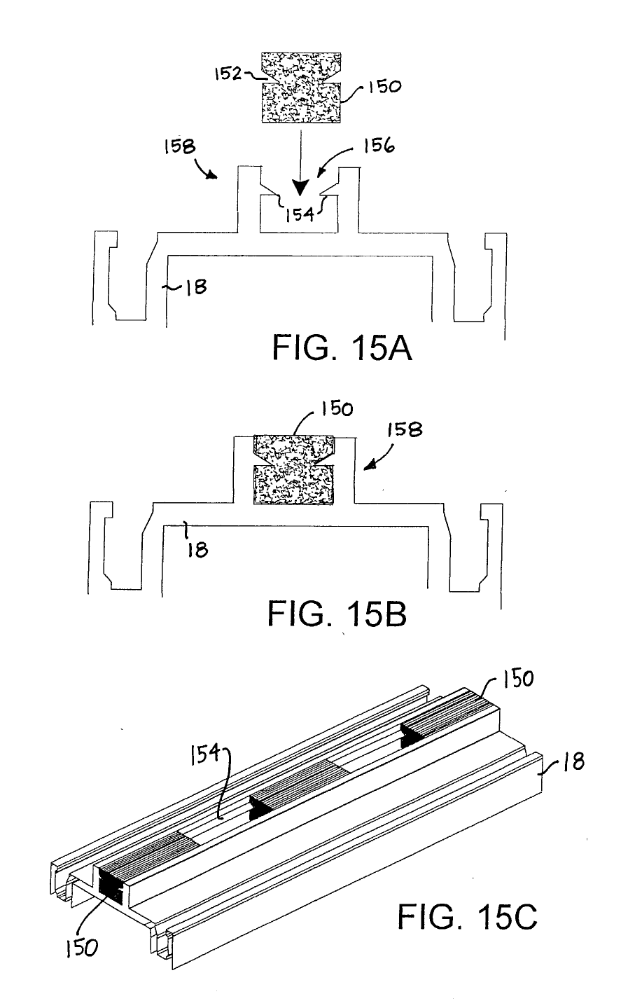

FIGS. 15A-15B illustrate an embodiment where the component 150 is provided with grooves 152 that are adapted to mate with corresponding rails 154 within the channel 156 provided in the mounting and spacing structure 158 of sash profile 18. As with the other embodiments disclosed herein, the component 150 can comprise a desiccating and/or vapor barrier component. It can have any of various different shapes. For example, the component 150 can include flanges (not shown) at the top thereof to cover the top edges of the legs that form the mounting and spacing structure 158. In this manner, a continuous seal would be provided from glazing pane to glazing pane, providing, e.g., an effective vapor barrier.

Although snap-in blocks 150 are illustrated in FIGS. 15A-15C, other structures, such press fit or adhesively mounted blocks could be provided. Any number of snaps or interlocking elements can be used alone or together with an adhesive or pressure fit to retain the component in the channel. Moreover, a continuous strip could be used for component 150, instead of the separate spaced blocks 150 shown in the FIG. 15C. The component 150 can be of any suitable material that serves the desired desiccating and/or vapor barrier function(s), including any of the materials disclosed herein in connection with other embodiments of the invention.

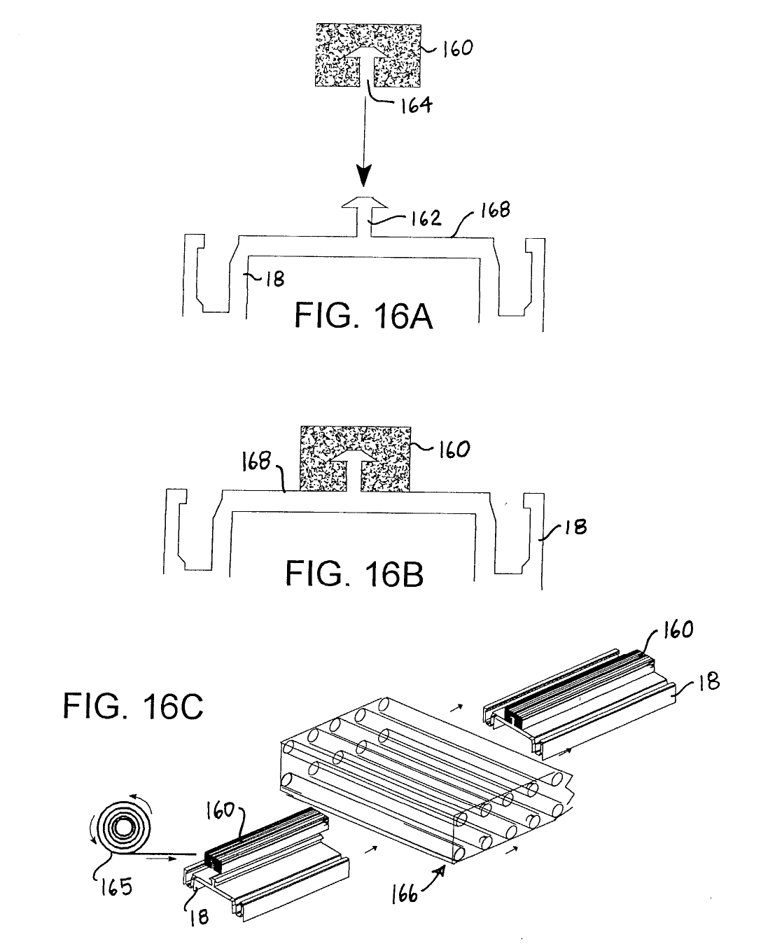

FIGS. 16A-16B illustrate an embodiment where the component 160 is mounted to the sash profile using another type of snap-fit. In particular, a post 162 is provided on the sash profile 18. The post 162 is adapted to snap into a corresponding receptacle 164 in the component 160. Other shapes can be provided for the snap-fit, as will be apparent to those skilled in the art. FIG. 16C illustrates an automated process for installing the component 160 onto the sash profile 18. As shown, the component can be provided in roll form 165, and pressed into place on the sash profile by a series of rollers 166. A conventional conveying apparatus can be used to feed the sash profile and roll fed component into the roller mechanism.

The component 160 of FIGS. 16A-16C can be a desiccating and/or vapor barrier material. Any of the materials described in connection with the other embodiments disclosed herein can also be used for the component 160. It should also be appreciated that in addition to the snap-fit, sealants and/or other adhesives can be used to further secure component 160 to sash profile 18. Such sealants and/or adhesives can be provided at the interface between post 162 and receptacle 164, and/or at the corners where the component 160 meets the base 168 of the sash profile.

It should now be appreciated that the present invention provides advantageous components for use in the manufacture of multipane window units, including such units manufactured from a sash assembly with an integral glazing pane mounting structure. The components of the present invention can provide desiccant, vapor barrier and/or sealant properties.

Although the invention has been described in connection with various particular embodiments, it should be appreciated that many adaptations and modifications may be made thereto without departing from the scope of the invention, as set forth in the claims. For example, various features of one disclosed embodiment can be used and/or substituted for features of the other embodiments.

What is claimed is:

1. A component for a multipane window unit sash assembly having an integral glazing pane mounting structure,
said mounting structure comprising an interior channel having two interior side walls and an interior bottom wall; and
said component comprising:
at least one of a desiccant or vapor barrier material applied to the two interior side walls and bottom wall.

2. A component in accordance with claim 1, wherein said material is extruded onto said side and bottom walls.

3. A component in accordance with claim 1, wherein said material is sprayed onto said side and bottom walls.

4. A component in accordance with claim 1, wherein said side walls terminate at top edges extending from said channel, and material is also applied to said top edges.

5. A component in accordance with claim 1, wherein said material has both desiccating and vapor barrier properties.

6. A component in accordance with claim 1, wherein said material comprises at least one of a tape, foam, adhesive, sealant, resin, metallic or plastic material.

7. A component in accordance with claim 6, wherein said material extends from a top edge of a first one of the interior side walls to said bottom wall, across said bottom wall, and continues to a top edge of the second one of the interior side walls.

8. A component in accordance with claim 7, wherein said material covers said top edges.

9. A component in accordance with claim 8, wherein said material continues past said top edges onto exterior surfaces of said mounting structure.

10. A component in accordance with claim 6, wherein said material is preformed to fit into said interior channel.

11. A component in accordance with claim 6, wherein:
said mounting structure is adapted to receive at least one glazing pane; and
said material has a projection extending therefrom for receiving at least one additional glazing pane.

12. A component in accordance with claim 11, wherein said mounting structure is adapted to receive two glazing panes, and said projection is adapted to receive at least a third glazing pane.

13. A component in accordance with claim 1, wherein said component is adapted to be mounted to said mounting structure by at least one of a snap or pressure fit.

14. A glazing pane mount for a multipane window unit sash assembly, comprising:
a spacer for attachment to said sash;
said spacer having:
mounting surfaces for at least two glazing panes, and
at least one retaining element between said mounting surfaces.

15. A glazing pane mount in accordance with claim 14, wherein said at least one retaining element comprises at least one groove in said spacer for retaining at least one of a muntin bar or additional glazing pane.

16. A glazing pane mount in accordance with claim 15, wherein said at least one groove is adapted to accommodate a retaining element for a muntin bar.

17. A glazing pane mount in accordance with claim 16, wherein two substantially parallel grooves are provided in said spacer to accommodate said retaining element.

18. A glazing pane mount in accordance with claim 16, wherein said retaining element comprises a clip adapted to snap into said at least one groove.

19. A glazing pane mount in accordance with claim 15, wherein said at least one groove is adapted to receive the end of a muntin bar or the edge of an additional glazing pane.

20. A glazing pane mount in accordance with claim 14, wherein said spacer comprises at least one of a preformed tape, foam, adhesive, sealant, resin, metallic or plastic material adhesively mounted to said sash.

21. A glazing pane mount in accordance with claim 14, wherein:
said mounting surfaces are provided on flanges extending from said spacer; and
each flange in combination with said sash defines a respective channel therebetween for accommodating at least one of a sealant or adhesive.

22. A glazing pane mount in accordance with claim 21, wherein said at least one sealant or adhesive is adapted to adhesively mount said glazing panes in position with respect to the spacer.

23. A glazing pane mount in accordance with claim 22, wherein said at least one sealant or adhesive is adapted to substantially fill said channel.

24. A glazing pane mount in accordance with claim 14, wherein said spacer is adapted to be attached to said sash by at least one of a snap or pressure fit.

25. A glazing pane mount for a multipane window unit sash assembly, comprising:
a spacer for attachment to said sash;
said spacer having mounting surfaces for at least two glazing panes;
wherein:
said mounting surfaces are provided on flanges extending from said spacer; and
said flanges in combination with said sash define a channel therebetween for accommodating at least one of a sealant or adhesive.

26. A glazing pane mount in accordance with claim 25, wherein said at least one sealant or adhesive is adapted to adhesively mount said glazing panes in position with respect to the spacer.

27. A glazing pane mount in accordance with claim 25, wherein edges of said flanges provide a first seal to said glazing pane, and said at least one sealant or adhesive provides a second seal to said glazing pane.

28. A glazing pane mount in accordance with claim 25, wherein said spacer comprises at least one of a tape, foam, adhesive, sealant, resin, metallic or plastic material.

29. A glazing pane mount in accordance with claim 25, wherein said spacer is preformed.

30. A glazing pane mount in accordance with claim 25, wherein said spacer is adapted to snap onto said sash.

31. A component for a multipane window unit sash assembly having an integral glazing pane mounting structure,
said mounting structure comprising at least two upright walls each connected to a respective transverse top wall portion; and
said component comprising:
at least one of a desiccant or vapor barrier material applied to the two upright walls and top wall portions.

32. A component in accordance with claim 31, wherein said respective transverse top wall portions are unconnected to each other.

33. A component in accordance with claim 31, wherein said respective transverse top wall portions are connected to each other.

34. A component in accordance with claim 31, wherein said material is extruded onto said upright and top wall portions.

35. A component in accordance with claim 34, wherein said material covers substantially all exterior surfaces of the upright and top wall portions.

36. A component in accordance with claim 35, wherein said respective transverse top wall portions are connected to each other and said material extends all of the way thereacross.

37. A component in accordance with claim 31, wherein at least one of a sealant or adhesive is applied to an exterior surface of said material on each of said upright walls, for use in mounting respective glazing panes to said upright walls via said material.

38. A component in accordance with claim 31, wherein said material has both desiccating and vapor barrier properties.

39. A component in accordance with claim 31, wherein said material comprises at least one of a tape, foam, adhesive, sealant, resin, metallic or plastic material.

40. A component in accordance with claim 39, wherein said material is preformed to fit over said mounting structure.

41. A component in accordance with claim 40, wherein:
said mounting structure is adapted to receive at least one glazing pane via said material adjacent at least one of said upright walls; and
said material has a projection extending therefrom for receiving at least one additional glazing pane.

42. A component in accordance with claim 41, wherein said mounting structure is adapted to receive two glazing panes, and said projection is adapted to receive at least a third glazing pane.

43. A component in accordance with claim 31, wherein:
said respective transverse top wall portions are unconnected to each other with a space therebetween; and
a portion of said component is adapted to fit into said space.

44. A component in accordance with claim 43, wherein said portion of said component is adapted to snap into said space.

45. A component in accordance with claim 31, wherein said component is provided in roll form for application to said mounting structure.

46. A component for a multipane window unit sash assembly having an integral glazing pane mounting structure,
said mounting structure comprising an upright wall having first and second opposed surfaces extending from a base portion of said sash assembly; and
said component comprising:
at least one of a desiccant or vapor barrier material applied to said base portion adjacent to the first surface of said upright wall;
wherein:
said second surface of said upright wall provides a mounting surface for a first glazing pane, and
said component provides a mounting surface for a second glazing pane.

47. A component in accordance with claim 46, wherein said material comprises at least one of a tape, foam, adhesive, sealant, resin, metallic or plastic material.

48. A component in accordance with claim 46, wherein said material is extruded onto said base portion.

49. A component in accordance with claim 46, wherein said material has both desiccating and vapor barrier properties.

50. A component in accordance with claim 46, wherein said component serves as a spacer to maintain a fixed space between said first and second glazing panes.

51. A component in accordance with claim 46, wherein said first surface of said upright wall provides a mounting surface for a third glazing pane.

52. A component in accordance with claim 46, wherein the component is adhesively applied to at least one of said base portion and said first surface.

53. A component in accordance with claim 46, wherein the component is mechanically applied to at lease one of said base portion or said first surface.

54. A component in accordance with claim 53, wherein the component is adapted to snap onto at least one of said base portion or said first surface.

55. A component for a multipane window unit sash assembly having an integral glazing pane mounting structure,
said mounting structure comprising an interior channel; and
said component comprising:
at least one of a desiccant or vapor barrier material adapted to be snapped or press fit into said interior channel.

56. A component in accordance with claim 55, wherein said component comprises a continuous strip of said material.

57. A component in accordance with claim 55, wherein said component comprises a plurality of separate blocks of said material adapted to be placed into said interior channel in spaced relation to one another.
